(19) United States
(12) Patent Application Publication
(10) Pub. No.: US 2025/0330791 A1
(43) Pub. Date: Oct. 23, 2025

(54) METHOD AND APPARATUS FOR DISCOVERY MESSAGE FORWARDING IN A WIRELESS COMMUNCATION SYSTEM

(71) Applicant: ASUS Technology Licensing Inc., Taipei City 112028 (TW)

(72) Inventor: Richard Lee-Chee Kuo, Taipei City (TW)

(21) Appl. No.: 19/076,464

(22) Filed: Mar. 11, 2025

Related U.S. Application Data
(60) Provisional application No. 63/637,162, filed on Apr. 22, 2024.

(51) Int. Cl. H04W 8/00; H04W 40/12; H04W 88/04

(52) U.S. Cl. CPC H04W 8/005; H04W 40/12; H04W 88/04

(57) ABSTRACT

A method and device for supporting multi-hop UE-to-Network (U2N) relay are disclosed. In one embodiment, a first relay UE is configured by upper layer to transmit a second U2N Relay Discovery message in response to reception of a first U2N Relay Discovery message from a second relay UE. Furthermore, the first relay UE determines whether to transmit the second U2N Relay Discovery message according to at least a reference signal received power (RSRP) measurement of a serving or camping cell, wherein the first relay UE transmits the second U2N Relay Discovery message if the RSRP measurement is below threshLowRelay and does not transmit the second U2N Relay Discovery message if the RSRP measurement is above threshHighRelay.

### CROSS-REFERENCE TO RELATED APPLICATIONS

The present application claims the benefit of U.S. Provisional patent application Ser. No. 63/637,162 filed on Apr. 22, 2024, the entire disclosure of which is incorporated herein in its entirety by reference.

### FIELD

This disclosure generally relates to wireless communication networks, and more particularly, to a method and apparatus for discovery message forwarding in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for supporting multi-hop UE-to-Network (U2N) relay are disclosed. In one embodiment, a first relay UE is configured by upper layer to transmit a second U2N Relay Discovery message in response to reception of a first U2N Relay Discovery message from a second relay UE. Furthermore, the first relay UE determines whether to transmit the second U2N Relay Discovery message according to at least a reference signal received power (RSRP) measurement of a serving or camping cell, wherein the first relay UE transmits the second U2N Relay Discovery message if the RSRP measurement is below threshLowRelay and does not transmit the second U2N Relay Discovery message if the RSRP measurement is above threshHighRelay.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 16.12.5.1-1 of 3GPP TS 38.300 V18.1.0.

FIG. 6 is a reproduction of FIG. 8.2.1.2.2.2.1 of 3GPP TS 24.554 V18.4.0.

FIG. 7 is a reproduction of FIG. 6.Y.1-1 of 3GPP S2-2403687.

FIG. 8 is a reproduction of FIG. 6.Y.2.1.1-1 of 3GPP S2-2403687.

FIG. 9 is a reproduction of FIG. 6.Y.2.1.2-1 of 3GPP S2-2403687.

FIG. 10 illustrates examples of relay UE locations with respect to its serving or camping cell according to one exemplary embodiment.

FIG. 11 illustrates three potential relay paths between the Remote UE and the network via multiple U2N relay UEs according to one exemplary embodiment.

FIG. 12 is a flow chart according to one exemplary embodiment.

FIG. 13 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 38.300 V18.1.0, “NR; N_{R} and NG-RAN Overall Description; Stage 2 (Release 18)”; TS 24.554 V18.4.0, “Proximity-services (ProSe) in 5G System (5GS) protocol aspects; Stage 3 (Release 18)”; TS 38.331 V18.1.0, “NR; Radio Resource Control (RRC) protocol specification (Release 18)”; TS 22.261 V19.3.0, “Service requirements for the 5G system; Stage 1 (Release 19)”; and S2-2403687, “New solution proposal: Support of multi-hop UE-to-Network Relays”, Qualcomm Incorporated, AT & T, FirstNet, and Samsung. The standards and documents listed above are hereby expressly incorporated by reference in their entirety.

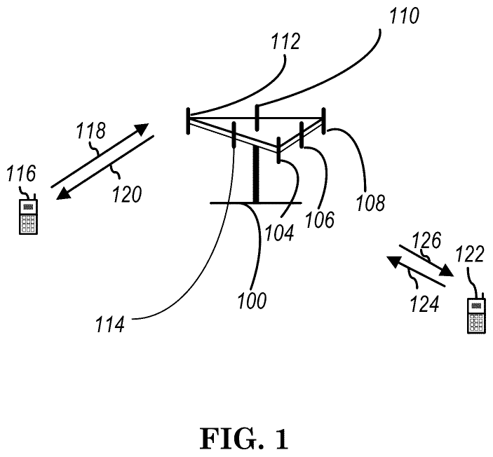

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

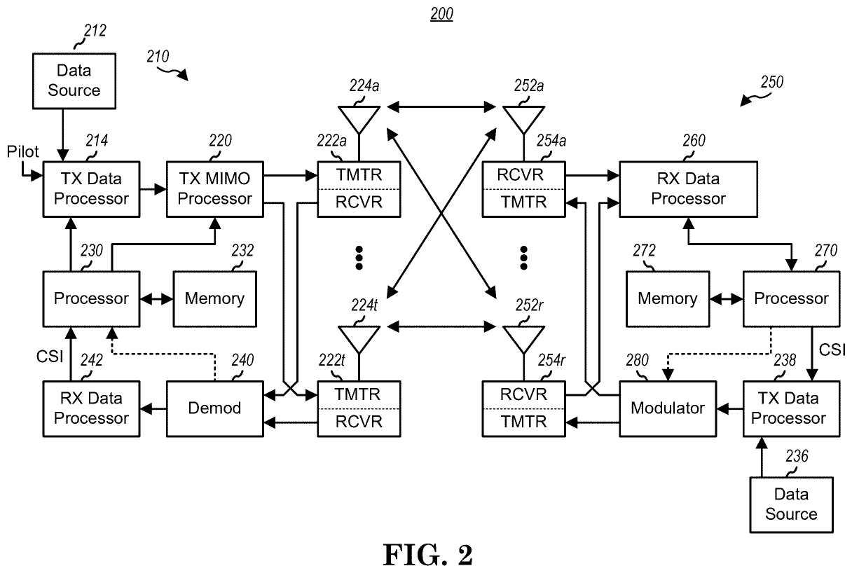

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

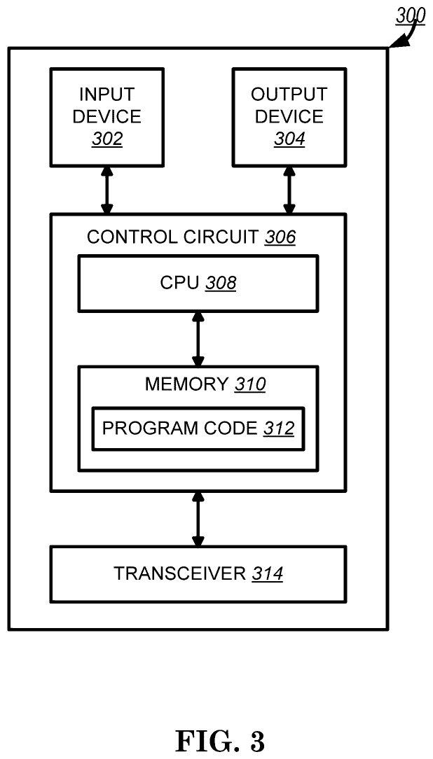

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

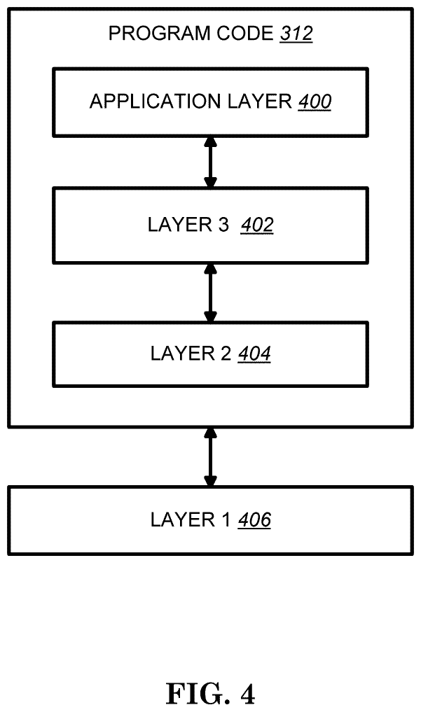

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 38.300 specifies procedures related to UE-to-Network Relay as follows:

### 16.12 Sidelink Relay

### 16.12.1 General

Sidelink relay supports 5G ProSe UE-to-Network Relay (U2N Relay) function (specified in TS 23.304 [48]) to provide connectivity to the network for U2N Remote UE(s). Both L2 and L3 U2N Relay architectures are supported. The L3 U2N Relay architecture is transparent to the serving NG-RAN of the U2N Relay UE, except for controlling sidelink resources. The detailed architecture and procedures for L3 U2N Relay can be found in TS 23.304 [48]. A U2N Relay UE shall be in RRC_CONNECTED to perform relaying of unicast data. For L2 U2N Relay operation, the following RRC state combinations are supported:
Both L2 U2N Relay UE and L2 U2N Remote UE shall be in RRC_CONNECTED to perform transmission/reception of relayed unicast data; and
The L2 U2N Relay UE can be in RRC_IDLE, RRC_INACTIVE or RRC_CONNECTED as long as all the L2 U2N Remote UE(s) that are connected to the L2 U2N Relay UE are either in RRC_INACTIVE or in RRC_IDLE.

A single unicast link is established between one L2 U2N Relay UE and one L2 U2N Remote UE. The traffic to the NG-RAN of L2 U2N Remote UE via a given L2 U2N Relay UE and the traffic of the L2 U2N Relay UE shall be separated in different Uu RLC channels.

For L2 U2N Relay, the L2 U2N Remote UE can only be configured to use resource allocation mode 2 (as specified in 5.7.2 and 16.9.3.1) for data to be relayed.

### 16.12.3 Relay Discovery

Model A and Model B discovery models as defined in TS 23.304 are supported for U2N Relay discovery. The protocol stack used for discovery is illustrated in FIG. 16.12.3-1.

The U2N Remote UE can perform Relay discovery message (i.e., as specified in TS 23.304 [48]) transmission and may monitor the sidelink for Relay discovery message while in RRC_IDLE, RRC_INACTIVE or RRC_CONNECTED. The network may broadcast or configure via dedicated RRC signalling a Uu RSRP threshold, which is used by the U2N Remote UE to determine if it can transmit Relay discovery messages to U2N Relay UE(s).

The U2N Relay UE can perform Relay discovery message (i.e., as specified in TS 23.304 [48]) transmission and may monitor the sidelink for Relay discovery message while in RRC_IDLE, RRC_INACTIVE or RRC_CONNECTED. The network may broadcast or configure via dedicated RRC signalling a maximum Uu RSRP threshold, a minimum Uu RSRP threshold, or both, which are used by the U2N Relay UE to determine if it can transmit Relay discovery messages to U2N Remote UE(s).

The U2U Remote UE and U2U Relay UE can perform Relay discovery message transmission or DCR/DCA message with integrated discovery transmission and may monitor for Relay discovery message or DCR/DCA message with integrated discovery while in coverage (i.e. RRC_IDLE, RRC_INACTIVE, or RRC_CONNECTED) or out-of-coverage.

The network may provide the Relay discovery configuration using broadcast or dedicated signalling. In addition, the U2N/U2U Remote UE, L3 U2N Relay UE and U2U Relay UE may use pre-configuration for Relay discovery.

The resource pool(s) used for N_{R} sidelink communication can be used for Relay discovery or the network may configure resource pool(s) dedicated for Relay discovery. Resource pool(s) dedicated for Relay discovery can be configured simultaneously with resource pool(s) for NR sidelink communication in system information, dedicated signalling and/or pre-configuration.

Whether dedicated resource pool(s) for Relay discovery are configured is based on network implementation. If resource pool(s) dedicated for Relay discovery are configured, only those resource pool(s) dedicated for Relay discovery shall be used for Relay discovery. If only resource pool(s) for N_{R} sidelink communication are configured, all the configured resource pool(s) can be used for Relay discovery and N_{R} sidelink communication. Only the resource pool for N_{R} sidelink communication is used for the DCR/DCA message with integrated discovery.

For U2N Remote UE (including both in-coverage and out of coverage cases) that has been connected to the network via a U2N Relay UE, only resource allocation mode 2 is used for Relay discovery message transmission.

For in-coverage U2N Relay UE, and for both in-coverage and out of coverage U2N Remote UEs, NR sidelink resource allocation principles are applied for Relay discovery message transmission. For U2U Remote UE and U2U Relay UE, N_{R} sidelink resource allocation principles, both mode 1 and mode 2, can be applied for Relay discovery message transmission.

The sidelink power control for the transmission of Relay discovery messages is same as for NR sidelink communication.

No ciphering or integrity protection in PDCP layer is applied for the Relay discovery messages. The U2N/U2U Remote UE and U2N/U2U Relay UE can determine from SIB12 whether the gNB supports Relay discovery, or Non-Relay discovery, or both.

### 16.12.5 Control Plane Procedures for L2 U2N Relay

### 16.12.5.1 RRC Connection Management

The L2 U2N Remote UE needs to establish its own PDU sessions/DRBs with the network before user plane data transmission.

The N_{R} sidelink PC5 unicast link establishment procedures can be used to setup a secure unicast link between L2 U2N Remote UE and L2 U2N Relay UE before L2 U2N Remote UE establishes a Uu RRC connection with the network via L2 U2N Relay UE.

The establishment of Uu SRB1/SRB2 and DRB of the L2 U2N Remote UE is subject to Uu configuration procedures for L2 UE-to-Network Relay.

The following high level connection establishment procedure in FIG. 16.12.5.1-1 applies to a L2 U2N Relay and L2 U2N Remote UE:

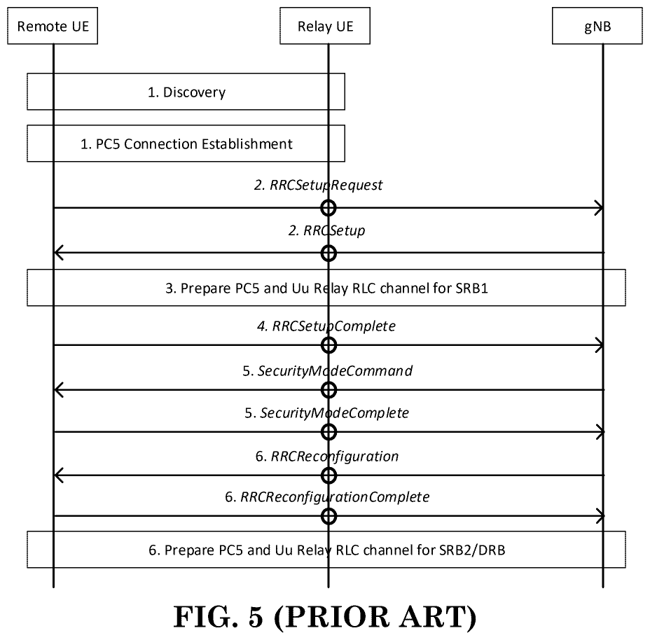

### FIG. 16.12.5.1-1 of 3GPP TS 38.300 V18.1.0, Entitled Procedure for L2 U2N Remote UE Connection Establishment”, is Reproduced as FIG. 5

1. The L2 U2N Remote and L2 U2N Relay UE perform discovery procedure, and establish a PC5-RRC connection using the N_{R} sidelink PC5 unicast link establishment procedure.
2. The L2 U2N Remote UE sends the first RRC message (i.e., RRCSetupRequest) for its connection establishment with gNB via the L2 U2N Relay UE, using a specified PC5 Relay RLC channel configuration. The L2 U2N Relay UE sends the SidelinkUEInformationNR message to request for the dedicated configurations required to support the relay operation for the L2 U2N Remote UE. If the L2 U2N Relay UE is not in RRC_CONNECTED, it needs to do its own Uu RRC connection establishment upon reception of a message on the specified PC5 Relay RLC channel. After L2 U2N Relay UE's RRC connection establishment procedure and sending the SidelinkUEInformationNR message, gNB configures SRB0 relaying Uu Relay RLC channel to the U2N Relay UE. The gNB responds with an RRCSetup message to L2 U2N Remote UE. The RRCSetup message is sent to the L2 U2N Remote UE using SRB0 relaying Uu Relay RLC channel over Uu and a specified PC5 Relay RLC channel over PC5.

### NOTE 1: Void.

3. The gNB and L2 U2N Relay UE perform relaying channel setup procedure over Uu. According to the configuration from gNB, the L2 U2N Relay/Remote UE establishes a PC5 Relay RLC channel for relaying of SRB1 towards the L2 U2N Remote/Relay UE over PC5.
4. The RRCSetupComplete message is sent by the L2 U2N Remote UE to the gNB via the L2 U2N Relay UE using SRB1 relaying channel over PC5 and SRB1 relaying channel configured to the L2 U2N Relay UE over Uu. Then the L2 U2N Remote UE is as in RRC_CONNECTED with the gNB.
5. The L2 U2N Remote UE and gNB establish security following the Uu security mode procedure and the security messages are forwarded through the L2 U2N Relay UE.
6. The gNB sends an RRCReconfiguration message to the L2 U2N Remote UE via the L2 U2N Relay UE, to setup the end-to-end SRB2/DRBs of the L2 U2N Remote UE. The L2 U2N Remote UE sends an RRCReconfigurationComplete message to the gNB via the L2 U2N Relay UE as a response. In addition, the gNB may configure additional Uu Relay RLC channels between the gNB and L2 U2N Relay UE, and PC5 Relay RLC channels between L2 U2N Relay UE and L2 U2N Remote UE for the relaying traffic.

3GPP TS 24.554 specifies UE-to-network relay discovery over PC5 interface with model A as follows:

8.2.1.2 UE-to-Network Relay Discovery Over PC5 Interface with Model A

### 8.2.1.2.1 General

In this procedure, the 5G ProSe UE-to-network relay UE acts as an “announcing UE” and the 5G ProSe remote UE acts as a “monitoring UE”.

### 8.2.1.2.2 Announcing UE Relay Discovery for UE-to-Network Relay Discovery

### 8.2.1.2.2.1 General

The purpose of the announcing UE procedure for UE-to-network relay discovery is:
a) to enable a ProSe-enabled UE to announce availability of a connectivity service provided by a UE-to-network relay of the ProSe-enabled UE to other ProSe-enabled UEs, upon a request from upper layers as defined in 3GPP TS 23.304 [2]; or
b) to enable a ProSe-enabled UE to measure the PROSE PC5 DISCOVERY message signal strength between the ProSe-enabled UE and the 5G ProSe UE-to-network relay UE(s) for relay selection/reselection.

### 8.2.1.2.2.2 Announcing UE Procedure for UE-to-Network Relay Discovery Initiation

The UE is authorised to perform the announcing UE procedure for UE-to-network relay discovery if:
a) the UE is authorised to act as a UE-to-network relay in the PLMN indicated by the serving cell as specified in clause 5.2.5, and
   1) the UE is served by NG-RAN and the UE is authorised to perform 5G ProSe direct discovery in the PLMN as specified in clause 5; or
   2) the UE is authorised to perform 5G ProSe direct discovery when not served by NG-RAN as specified in clause 5 and intends to use the provisioned radio resources for UE-to-network relay discovery;
b) the UE is configured with:
   1) the relay service code parameter identifying the connectivity service to be announced as specified in clause 5.2.5 and the indicated security procedure for the relay service code is supported by the UE. For 5G ProSe layer-3 UE-to-network relay UE,
      i) the S-NSSAI associated with that relay service code shall belong to the allowed NSSAI of the UE; and
      ii) if the UE is camped on a cell whose TAI is in the list of “non-allowed tracking areas” or is camped on a cell whose TAI is not in the list of “allowed tracking areas”, then the relay service code shall be associated with high priority access as defined in clause 5.3.5 of 3GPP TS 24.501 [11]; and
   2) the User info ID for the UE-to-network relay discovery parameter as specified in clause 5.2.5;
c) for 5G ProSe layer-3 UE-to-network relay UE, the UE is configured with PDU Session parameters which is used for relayed traffic for the associated relay service code, as specified in clause 5.2.5; and
d) the back-off timer T3346 used for NAS mobility management congestion control as specified in clause 5.3.9 of 3GPP TS 24.501 is not running at the UE;
otherwise, the UE is not authorised to perform the announcing UE procedure for UE-to-network relay discovery.

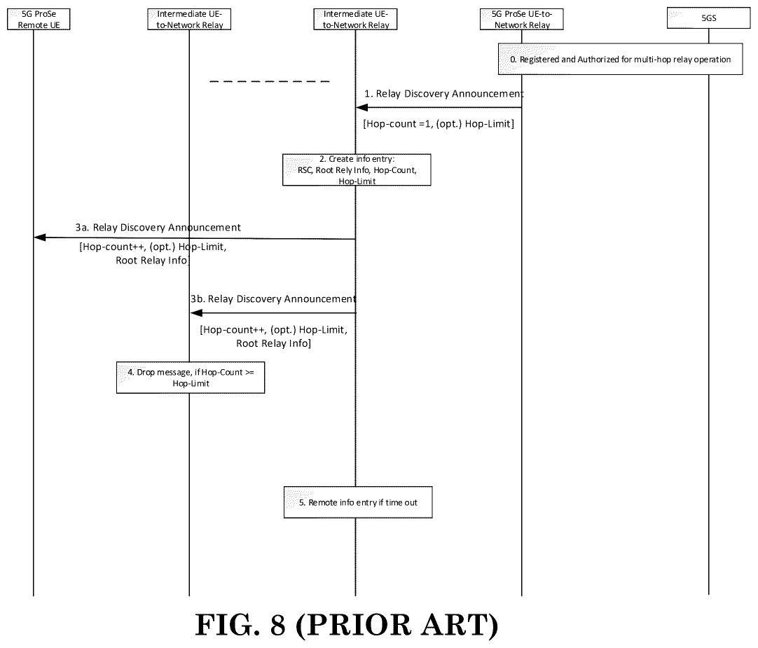

FIG. 8.2.1.2.2.2.1 illustrates the interaction of the UEs in the announcing UE procedure for UE-to-network relay discovery.

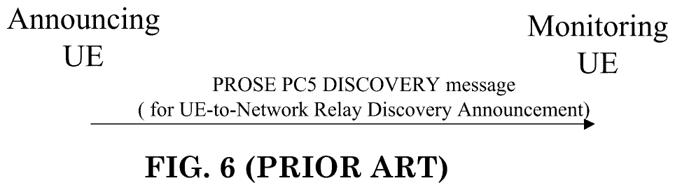

### FIG. 8.2.1.2.2.2.1 of 3GPP TS 24.554 V18.4.0, Entitled “Announcing UE Procedure for UE-to-Network Relay Discovery”, is Reproduced as FIG. 6

When the UE is triggered by an upper layer application to announce availability of a connectivity service provided by a UE-to-network relay, if the UE is authorised to perform the announcing UE procedure for UE-to-network relay discovery, then the UE:
a) if the UE is served by NG-RAN and the UE in 5GMM-IDLE mode needs to request resources for sending PROSE PC5 DISCOVERY messages for relay discovery as specified in 3GPP TS 38.331 [13], shall perform a service request procedure or mobility registration procedure as specified in 3GPP TS 24.501 [11];
b) shall obtain a valid UTC time for the discovery transmission from the lower layers and generate the UTC-based counter corresponding to this UTC time as specified in clause 11.2.5;
c) shall generate a PROSE PC5 DISCOVERY message for UE-to-network relay discovery announcement according to clause 10.2.1. In the PROSE PC5 DISCOVERY message for UE-to-network relay discovery announcement, the UE:
   1) shall set the announcer info parameter to the User info ID configured for the UE-to-network relay discovery, as specified in clause 5.2.5;
   2) shall set the relay service code parameter to the relay service code configured for the connectivity service to be announced, as specified in clause 5.2.5. The relay service code parameter is set to relay service code specific for emergency service if the UE is triggered by an upper layer application to announce availability of an emergency connectivity service provided by a UE-to-network relay, and either of the following:
      i) for 5G ProSe layer-2 UE-to-network relay UE, the UE received an indication from the lower layers that the cell supports IMS emergency bearer services for UEs in limited service mode as specified in 3GPP TS 38.331 [13]; or
      ii) for 5G ProSe layer-3 UE-to-network relay UE, the EMC bit in the 5GS network feature support IE of the REGISTRATION ACCEPT message is not set to “Emergency services not supported” as specified in 3GPP TS 24.501 and the UE is neither using its own emergency service nor relaying the emergency services from one 5G ProSe layer-3 remote UE;
   3) shall include the MIC field computed as described in 3GPP TS 33.503 [34], by using the UTC-based counter and the DUIK contained in the <UNR-discovery-security-parameters-accept> element of the PROSE_SECURITY_PARAM_RESPONSE message;
   4) shall set the UTC-based counter LSB parameter to the 4 least significant bits of the UTC-based counter;
   5) shall set the Resource Status Indicator bit of the status indicator parameter to indicate whether or not the UE has resources available to provide a connectivity service for additional ProSe-enabled UEs;
   6) shall set the ProSe direct discovery PC5 message type parameter as specified in table 10.2.1.8;
   7) if acting as 5G ProSe layer-2 UE-to-network relay UE, shall set the NCGI parameter to the NCGI of its serving cell; and
   8) if acting as 5G ProSe layer-2 UE-to-network relay UE, shall set the RRC container to the RRC container if provided by the lower layers;
d) shall apply the DUIK, DUSK, or DUCK with the associated Encrypted Bitmask, along with the UTC-based counter to the PROSE PC5 DISCOVERY message for whichever security mechanism(s) configured to be applied, e.g., integrity protection, message scrambling or confidentiality protection of one or more above parameters, as specified in 3GPP TS 33.503 [34];
e) shall set the destination layer-2 ID to the default destination layer-2 ID as specified in clause 5.2.5 and self-assign a source layer-2 ID for sending the UE-to-network relay discovery announcement; and

NOTE 1: The UE implementation ensures that the value of the self-assigned source layer-2 ID is different from any other self-assigned source layer-2 ID(s) in use for 5G ProSe direct communication as specified in clause 7.2, is different from any other provisioned destination layer-2 ID(s) as specified in clause 5.2 and is different from any other self-assigned source layer-2 ID in use for a simultaneous 5G ProSe direct discovery procedure over PC5 with a different discovery model as specified in clause 6.2.14.2.2.2, clause 6.2.15.2.2.2 and clause 8.2.1.3.1.2.
f) shall pass the resulting PROSE PC5 DISCOVERY message for UE-to-network relay discovery announcement to the lower layers for transmission over the PC5 interface with the source layer-2 ID, destination layer-2 ID and an indication that the message is for 5G ProSe direct discovery.

The UE shall maintain the association(s) between the self-assigned source layer-2 ID and relay service code once generating the PROSE PC5 DISCOVERY message. Each self-assigned source layer-2 ID can be associated with only one relay service code.

The UE shall ensure that it keeps on passing the same PROSE PC5 DISCOVERY message along with the same source layer-2 ID, destination layer-2 ID and an indication that the message is for 5G ProSe direct discovery to the lower layers for transmission until the UE is triggered by an upper layer application to stop announcing availability of a connectivity service provided by a UE-to-network relay, or until the UE stops being authorised to perform the announcing UE procedure for UE-to-network relay discovery. How this is achieved is left up to UE implementation.
NOTE 2: The announcing UE can stop announcing UE procedure for UE-to-network relay discovery for power saving by implementation specific means e.g. an implementation-specific maximum number of 5G ProSe direct links configured in the UE, or an implementation-specific timer expires.

3GPP TS 38.331 specifies sidelink discovery transmission as follows:

### 5.8.13.3 N_{R} Sidelink Discovery Transmission

A UE capable of N_{R} sidelink discovery that is configured by upper layer to transmit N_{R} sidelink discovery message shall:
1> if the frequency used for N_{R} sidelink discovery is included in sl-FreqInfoToAddModList in sl-ConfigDedicatedNR within RRCReconfiguration message; or if the frequency used for N_{R} sidelink discovery is included in sl-FreqInfoList within SIB12:
   2> if the UE is in RRC_CONNECTED and uses the frequency included in sl-ConfigDedicatedNR within RRCReconfiguration message:
      3> if the UE is acting as N_{R} sidelink U2N Relay UE and sl-DiscConfig is included in RRCReconfiguration, and if the N_{R} sidelink U2N Relay UE threshold conditions as specified in 5.8.14.2 are met based on sl-RelayUE-Config; or
      3> if the UE is selecting N_{R} sidelink U2N Relay UE/has a selected N_{R} sidelink U2N Relay UE/configured with measurement object associated to L2 U2N Relay UEs and sl-DiscConfig is included in RRCReconfiguration, and if the N_{R} sidelink U2N Remote UE threshold conditions as specified in 5.8.15.2 are met based on sl-RemoteUE-Config; or
      3> if the UE is selecting N_{R} sidelink U2U Relay UE/has a selected N_{R} sidelink U2U Relay UE and sl-DiscConfig is included in RRCReconfiguration, and if the N_{R} sidelink U2U Remote UE threshold conditions associated with the peer N_{R} Sidelink U2U Remote UE as specified in 5.8.17.2 are met based on sl-RemoteUE-ConfigU2U; or
      3> if the UE acting as Target Remote UE is performing U2U Relay Discovery with Model B and sl-DiscConfig is included in RRCReconfiguration, and if the N_{R} sidelink U2U Remote UE threshold conditions associated with the N_{R} sidelink U2U Relay UE as specified in 5.8.17.2 are met based on sl-RemoteUE-ConfigU2U; or
      3> if the UE acting as U2U Relay UE is performing U2U Relay Discovery with Model A as specified in TS 23.304 [65], and neighbour UEs in discovery message to be transmitted meet the threshold conditions as specified in 5.8.16.3; or
      3> if the UE acting as U2U Relay UE is sending Discovery Response message with Model B as specified in TS 23.304 [65]; or
      3> if the UE acting as U2U Relay UE is sending Discovery Solicitation message with Model B as specified in TS 23.304 [65] and sl-DiscConfig is included in RRCReconfiguration, and if the N_{R} sidelink U2U Relay UE threshold conditions as specified in 5.8.16.2 are met based on sl-RelayUE-ConfigU2U; or

NOTE 1: For U2U Relay UE and Target Remote UE, it can be up to UE implementation on cross-layer interaction for the AS layer condition check for discovery message forwarding.
3> if the UE is performing N_{R} sidelink non-relay discovery:
   4> if the UE is configured with sl-ScheduledConfig:
      5> if T310 for MCG or T311 is running; and if sl-TxPoolExceptional is included in sl-FreqInfoList for the concerned frequency in SIB12 or included in sl-ConfigDedicatedNR in RRCReconfiguration; or
      5> if T301 is running and the cell on which the UE initiated RRC connection re-establishment provides SIB12 including sl-TxPoolExceptional for the concerned frequency; or
      5> if T304 for MCG is running and the UE is configured with sl-TxPoolExceptional included in sl-ConfigDedicatedNR for the concerned frequency in
         RRCReconfiguration:
         6> configure lower layers to perform the sidelink resource allocation mode 2 based on random selection using the resource pool indicated by sl-TxPoolExceptional as defined in TS 38.321 [3] for N_{R} sidelink discovery transmission;
      5> else:
         6> configure lower layers to perform the sidelink resource allocation mode 1 using the resource pool indicated by sl-DiscTxPoolScheduling or sl-TxPoolScheduling for N_{R} sidelink discovery transmission on the concerned frequency in RRCReconfiguration;

### 5.8.14 N_{R} Sidelink U2N Relay UE Operation

### 5.8.14.1 General

This procedure is used by a UE supporting N_{R} sidelink U2N Relay UE operation configured by upper layers to transmit N_{R} sidelink discovery messages to evaluate AS layer conditions.

### 5.8.14.2 N_{R} Sidelink U2N Relay UE Threshold Conditions

A UE capable of N_{R} sidelink U2N Relay UE operation shall:
1> if the threshold conditions specified in this clause were previously not met:
   2> if threshHighRelay is not configured; or the RSRP measurement of the PCell, or the cell on which the UE camps, is below threshHighRelay by hystMaxRelay if configured; and
   2> if threshLowRelay is not configured; or the RSRP measurement of the PCell, or the cell on which the UE camps, is above threshLowRelay by hystMinRelay if configured:
      3> consider the threshold conditions to be met (entry);
1> else:
   2> if the RSRP measurement of the PCell, or the cell on which the UE camps, is above threshHighRelay if configured; or
   2> if the RSRP measurement of the PCell, or the cell on which the UE camps, is below threshLowRelay if configured;
      3> consider the threshold conditions not to be met (leave);

### 6.3.5 Sidelink Information Elements

SL-ConfigDedicatedNR

The IE SL-ConfigDedicatedNR specifies the dedicated configuration information for N_{R} sidelink communication/discovery/positioning.

SL-ConfigDedicatedNR information element

| | |
|---|---|
| SL-ConfigDedicatedNR-r16 ::= | SEQUENCE { |
| sl-PHY-MAC-RLC-Config-r16 | SL-PHY-MAC-RLC-Config-r16 |

OPTIONAL, -- Need M

| | |
|---|---|
| sl-RadioBearerToReleaseList-r16 | SEQUENCE (SIZE (1..maxNrofSLRB-r16)) OF SLRB-Uu- |

ConfigIndex-r16 OPTIONAL, -- Need N

| | |
|---|---|
| sl-RadioBearerToAddModList-r16 | SEQUENCE (SIZE (1..maxNrofSLRB-r16)) OF SL- |

RadioBearerConfig-r16 OPTIONAL, -- Need N

| | |
|---|---|
| sl-MeasConfigInfoToReleaseList-r16 | SEQUENCE (SIZE (1..maxNrofSL-Dest-r16)) OF SL- |

DestinationIndex-r16 OPTIONAL, -- Need N

| | |
|---|---|
| sl-MeasConfigInfoToAddModList-r16 | SEQUENCE (SIZE (1..maxNrofSL-Dest-r16)) OF SL- |

MeasConfigInfo-r16 OPTIONAL, -- Need N

| | |
|---|---|
| t400-r16 | ENUMERATED {ms100, ms200, ms300, ms400, ms600, ms1000, |

```
ms1500, ms2000} OPTIONAL, -- Need M
  ...,
  [[
```

| | |
|---|---|
| sl-PHY-MAC-RLC-Config-v1700 | SetupRelease { SL-PHY-MAC-RLC-Config-v1700 } |

OPTIONAL, -- Need M

| | |
|---|---|
| sl-DiscConfig-r17 | SetupRelease { SL-DiscConfig-r17} |

```
OPTIONAL -- Need M
  ]],
  [[
```

| | |
|---|---|
| sl-DiscConfig-v1800 | SL-DiscConfig-v1800 |

OPTIONAL -- Need M
]]
}
...

| | |
|---|---|
| SL-DiscConfig-r17::= | SEQUENCE { |
| sl-RelayUE-Config-r17 | SetupRelease { SL-RelayUE-Config-r17} |

OPTIONAL, -- Cond L2RelayUE

| | |
|---|---|
| sl-RemoteUE-Config-r17 | SetupRelease { SL-RemoteUE-Config-r17} |

OPTIONAL -- Cond L2RemoteUE
}
[...]
- SL-RelayUE-Config

The IE SL-RelayUE-Config specifies the configuration information for N_{R} sidelink U2N Relay UE.

SL-RelayUE-Config information element

-- ASN1START
-- TAG-SL-RELAYUE-CONFIG-START

| SL-RelayUE-Config-r17::= | SEQUENCE { | | |
|---|---|---|---|
| threshHighRelay-r17 | RSRP-Range | OPTIONAL, | -- |
| Need R | | | |
| threshLowRelay-r17 | RSRP-Range | OPTIONAL, | -- |
| Need R | | | |
| hystMaxRelay-r17 | Hysteresis | OPTIONAL, | -- |
| Cond ThreshHighRelay | | | |
| hystMinRelay-r17 | Hysteresis | OPTIONAL | -- |

Cond ThreshLowRelay
}
-- TAG-SL-RELAYUE-CONFIG-STOP
-- ASN1STOP

SL-RelayUE-Config field descriptions

threshHighRelay
Indicates the upper threshold of Uu RSRP for a UE
that is in network coverage to evaluate AS layer
conditions for U2N relay UE operation.
threshLowRelay
Indicates the lower threshold of Uu RSRP for a UE
that is in network coverage to evaluate AS layer
conditions for U2N relay UE operation.

| Conditional | |
|---|---|
| Presence | Explanation |
| ThreshHighRelay | This field is mandatory present if threshHighRelay is |
| | included. Otherwise, the field is absent, Need R. |
| ThreshLowRelay | This field is mandatory present if threshLowRelay is |
| | included. Otherwise, the field is absent, Need R. |

3GPP TS 22.261 specifies connectivity models and Key Performance Indicators (KPIs) for UE to network relaying in 5G system as follows:

### 6.9 Connectivity Models

### 6.9.1 Description

The UE (remote UE) can connect to the network directly (direct network connection), connect using another UE as a relay UE (indirect network connection), or connect using both direct and indirect connections. Relay UEs can be used in many different scenarios and verticals (inHome, SmartFarming, SmartFactories, Public Safety and others). In these cases, the use of relays UEs can be used to improve the energy efficiency and coverage of the system.

Remote UEs can be anything from simple wearables, such as sensors embedded in clothing, to a more sophisticated wearable UE monitoring biometrics. They can also be non-wearable UEs that communicate in a Personal Area Network such as a set of home appliances (e.g. smart thermostat and entry key), or the electronic UEs in an office setting (e.g. smart printers), or a smart flower pot that can be remotely activated to water the plant.

When a remote UE is attempting to establish an indirect network connection, there might be several relay UEs that are available in proximity and supporting selection procedures of an appropriate relay UE among the available relay UEs is needed.

Indirect network connection covers the use of relay UEs for connecting a remote UE to the 3GPP network. There can be one or more relay UE(s) (more than one hop) between the network and the remote UE.

A ProSe UE-to-UE Relay can also be used to connect two remote Public Safety UEs using direct device connection. There can be one or more ProSe UE-to-UE Relay(s) (more than one hop) between the two remote Public Safety UEs.

### 6.9.2 Requirements

The following set of requirements complement the requirements listed in 3GPP TS 22.278 [5], clauses 7B and 7C.

### 6.9.2.1 General

The 5G system shall support the relaying of traffic between a remote UE and a gNB using one or more relay UEs.

The 5G system shall support same traffic flow of a remote UE to be relayed via different indirect network connection paths.

The 5G system shall support different traffic flows of a remote UE to be relayed via different indirect network connection paths.

The connection between a remote UE and a relay UE shall be able to use 3GPP RAT or non-3GPP RAT and use licensed or unlicensed band.

The connection between a remote UE and a relay UE shall be able to use fixed broadband technology.

The 5G system shall support indirect network connection mode in a VPLMN when a remote UE and a relay UE subscribe to different PLMNs and both PLMNs have a roaming agreement with the VPLMN.

The 5G system shall be able to support a UE using simultaneous indirect and direct network connection mode.

The network operator shall be able to define the maximum number of hops supported in their networks when using relay UEs.

The 5G system shall be able to manage communication between a remote UE and the 5G network across multi-path indirect network connections.

3GPP S2-2403687 proposes a solution for multi-hop UE-to-Network Relay as follows:

### 6.Y Solution #Y: Architecture Enhancement to Support 5G ProSe Multi-Hop UE-to-Network Relays

### 6.Y.1 Description

The solution is illustrated with the architecture example as shown in FIG. 6.Y.1-1.

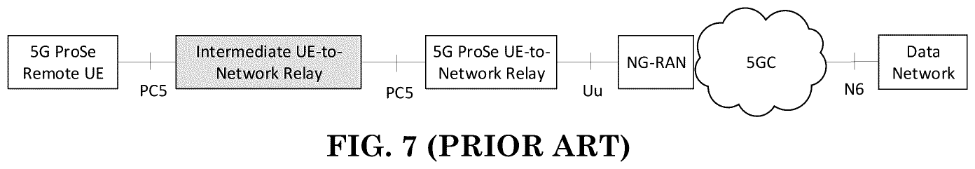

### FIG. 6.Y.1-1 of 3GPP S2-2403687, Entitled “Example Architecture of Multi-Hop UE-to-Network Relay”, is Reproduced as FIG. 7

Following operation principles are applied to support the 5G ProSe multi-hop UE-to-Network Relay operations to provide services to a 5G ProSe Remote UE:
Only 5G ProSe UE-to-Network Relay needs to be in coverage of NG-RAN and be able to establishes a connection with the NG-RAN.
Other Intermediate UE-to-Network Relay(s) can be either in coverage or out of coverage. However, for a particular RSC, a relay UE can act as either a 5G ProSe UE-to-Network Relay or an Intermediate UE-to-Network Relay. To act as an Intermediate UE-to-Network Relay, e.g. forwarding the Model A discovery message or replying to the Model B Discovery Response message, the relay UE needs to have a valid connection towards the network via the 5G ProSe UE-to-Network Relay indicated by the Root Relay Info IE. If the Intermediate UE-to-Network Relay need to also operate as a Remote UE, e.g. it is also running some other applications, it should follow the behavior defined for Remote UE independent from the Intermediate UE-to-Network Relay logic.
Relay Service Code (RSC), as defined in TS 23.304, is used for the indication of services offered by the 5G ProSe multi-hop UE-to-Network Relays. No special RSC is introduced for multi-hop operation, i.e. the 5G ProSe UE-to-Network Relay and the Intermediate UE-to-Network Relay use the same RSC.
The 5G ProSe UE-to-Network Relay and the Intermediate UE-to-Network Relays can serve other Intermediate UE-to-Network Relays and 5G ProSe Remote UE at the same time.
A Hop-Count IE is introduced to reflect the nature of multi-hop operation, in both discovery and connection establishment, and is used to control the number of hops to be supported for multi-hop Relay operations. A separate Hop-Limit IE is used for controlling the maximum hops, and the value of the Hop-Limit is configured by the network. If the Hop-Limit is not included in the discovery messages, the Intermediate Relays will locally use a (pre-) configured value for the control.
Editor's Note: It is FFS if the value of the Hop-Limit is determined by 3GPP or left to operator to decide, e.g. configured based on the service type supported by the RSC.
Editor's Note: It is FFS if other metrics besides hop limit can be supported for the relay path selection, e.g. the accumulated delay over the hops.
NOTE: when the number of hops increases, the performance over the multi-hop relay link would be affected, e.g. the overall delay, and the stability of the link, mobility caused signaling overhead, etc. Therefore, the setting of the hop limit value, which determines the max number of hops, need to be selected properly taking these into consideration.
Both Model A and Model B Discovery are supported for the 5G ProSe UE-to-Network Relay operation.
The 5G ProSe Remote UE only selects the Intermediate UE-to-Network Relay directly serving it, i.e. it does not need to be aware of the identities of the other Intermediate UE-to-Network Relays.
The 5G ProSe UE-to-Network Relay's identify is included in the UE-to-Network Relay Discovery message, to avoid message flooding and help 5G ProSe Remote UE's relay reselection.

### 6.Y.2 Procedures

### 6.Y.2.1 Relay Discovery

### 6.Y.2.1.1 Support of Model a Discovery

FIG. 6.Y.2.1.1-1 provides an example of how the Model A discovery is supported in the multi-hop relay environment.

### FIG. 6.Y.2.1.1-1 of 3GPP S2-2403687, Entitled “Example Model a Discovery Operation Supporting Multi-Hop UE-to-Network Relay”, is Reproduced as FIG. 8

For Model A discovery, the 5G ProSe UE-to-Network Relay reuses the 5G ProSe UE-to-Network Relay Discovery Announcement message as defined in TS 23.304 [4] clause 5.8.3, with the following additional IE:
Hop-Count: This value should be set to 1. It serves as an indication that the 5G ProSe UE-to-Network Relay supports multi-hop operation. In order to be legacy compliant, i.e. serving prior release 5G ProSe Remote UEs, the encoding of this Hop-Count should allow the 5G ProSe Remote UE not support multi-hop operation to ignore it and follow the existing procedures defined in TS 23.304 [4].
(optional) Hop-Limit: This indicates how many hops this 5G ProSe UE-to-Network Relay supports. Any Intermediate UE-to-Network Relay does not further forward the announcement message if the Hop-Count is equal or larger than the Hop-Limit. The value of the Hop-Limit is configured by the network. If the Hop-Limit is not included in the discovery messages, the Intermediate Relays will use a pre-configured value for the control.

For Model A discovery, the Intermediate UE-to-Network Relay(s) forwards the Announcement message with the following modifications:
Source Layer-2 ID: this is set to the source Layer-2 ID of the Intermediate UE-to-Network Relay.
Destination Layer-2 ID: the Destination Layer-2 ID for 5G ProSe UE-to-Network Relay Discovery is selected based on the configuration. It should be the same Destination Layer-2 ID of the Announcement message received by the Intermediate UE-to-Network Relay.
Announcer Info: identify information (i.e. User Info ID) of the announcing Intermediate UE-to-Network Relay.
Relay Service Code: no modification to the RSC of the received Announcement message.
Hop-Count: The Intermediate UE-to-Network Relay increment the value of the received Announcement message by 1 before forwarding it. If this value is equal or bigger than the optional Hop-Limit value in the message, the message is not forwarded. Additionally, if the Hop-Count value is equal or larger than a locally configured threshold on the Intermediate UE-to-Network Relay, it will not forward the Announcement message.
(optional) Hop-Limit: this should be kept unchanged from the value in the received message.
Root Relay Info: this is the User Info ID contained in the Announcer Info from the original 5G ProSe UE-to-Network Relay Discovery Announcement message. If included, it is not modified by the Intermediate UE-to-Network Relays.

The rest of the information contained in the Announcement messages is kept without modification when the message is forwarded by the Intermediate UE-to-Network Relays. The Intermediate UE-to-Network Relay(s) keeps a record of the RSC, Root Relay Info, Announcer Info, and the associated Hop-Count value. Optionally, the Hop-Limit value can be also stored. If it receives an Announcement message with the same RSC and Root Relay Info but different Announcer Info, it will only forward the Announcement message when the Hop-Count value is smaller than the stored value. In that case, the Intermediate UE-to-Network Relay updates it stored value, i.e. the Announcer Info and the Hop-Count value. These stored values should be timed out by the Intermediate UE-to-Network Relay based on a locally configured timer.

The Relay Discovery Additional Information message (using Model A) message as defined in TS 23.304 [4] clause 5.8.3 can be supported, similar to the additional handling for the Announcement message, i.e. by including the Hop-Count and (optional) Hop-Limit IE inside the message.

Editor's Note: It is FFS how Additional Information message for Model A discovery and related procedure are supported.

### 6.Y.2.1.2 Support of Model B Discovery

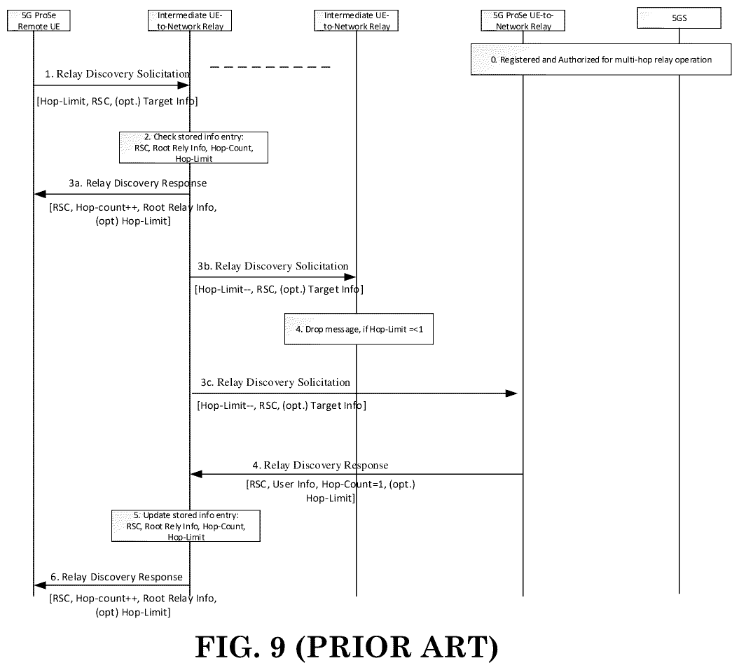

### FIG. 6.Y.2.1.2-1 of 3GPP S2-2403687, Entitled “Example Model B Discovery Operation Supporting Multi-Hop UE-to-Network Relay”, is Reproduced as FIG. 9

For Model B discovery, the 5G ProSe Remote UE uses the 5G ProSe UE-to-Network Relay Discovery Solicitation message (Model B), with the following modified/additional IE:
Discoverer Info: User Info ID of the 5G ProSe Remote UE.
(optional) Target Info: User Info ID of a particular 5G ProSe UE-to-Network Relay. This may be used by a Remote UE to find a new/alternative path towards the UE-to-Network Relay that provides/provided service to it.
Relay Service Code: the Relay Service Codes configured in the 5G ProSe Remote UEs for the service it interested in.
Hop-Limit: This indicates the max hop count of the 5G ProSe Remote UEs accepts on the path. Therefore, if an Intermediate UE-to-Network Relays's stored information as described in 6.Y.2.1.1 has a hop-count larger than the Hop-Limit, it does not respond to the Solicitation message. The 5G ProSe Remote UE can determine the value of the Hop-Limit based on the (pre-) configuration and ProSe Application requirements.

Additional information elements defined in the TS 23.304 [4] clause 5.8.3 are reused. The Intermediate UE-to-Network Relay checks its valid (unexpired) stored information entries (as described in clause 6.Y.2.1.1) against the received Solicitation message for the following criteria:
RSC of the received Solicitation message matches the stored value;
the optional Target Info match with the stored Root Relay Info; and
the Hop-Limit of the received message is larger than the stored Hop-Count.

If all the criteria are met, the Intermediate UE-to-Network Relay may respond with a 5G ProSe UE-to-Network Relay Discovery Response message (Model B) as defined in TS 23.304 [4] clause 5.8.3 with the following modified/additional information:
Source Layer-2 ID: the Source Layer-2 ID of the Intermediate UE-to-Network Relay.
Destination Layer-2 ID: set to the Source Layer-2 ID of the received 5G ProSe UE-to-Network Relay Discovery Solicitation message.
Relay Service Code: the RSC from the corresponding Discovery Solicitation message.
Discoveree Info: User Info ID of the Intermediate UE-to-Network Relay.
Hop-Count: this is the Hop-Count value of the stored entry incremented by 1. If the Hop-Count is bigger than the Hop-Limit, the message is dropped.
(optional) Hop-Limit: this is from the matched stored entry if available.
Root Relay Info: this is from the stored entry.

For any Intermediate UE-to-Network Relay received the 5G ProSe UE-to-Network Relay Discovery Response message (Model B), it updates/creates a new information entry as described in clause 6.Y.2.1.1.

The Intermediate UE-to-Network Relay does not have a stored entry matching all the criteria, it may forward the 5G ProSe UE-to-Network Relay Discovery Solicitation message. When forwarding the message, the Intermediate UE-to-Network Relay modifies the following IEs in the message:
Source Layer-2 ID: the Intermediate UE-to-Network Relay uses its own Source Layer-2 ID when forwarding the message.
Discoverer Info: User Info ID of the Intermediate UE-to-Network Relay.
(optional) Target Info: User Info ID of a particular 5G ProSe UE-to-Network Relay. This will be kept if it is present in the received message.
Relay Service Code: the RSC of the received message is kept unchanged.
Hop-Limit: the value in the received Solicitation message is decremented by 1 before it is forwarded. If the value reaches 1, the Intermediate UE-to-Network Relay does not forward the Solicitation message.

If a 5G ProSe UE-to-Network Relay received a Solicitation message, it checks the message against the following criteria:
RSC of the received Solicitation message matches the stored value;
the optional Target Info match its own User Info ID; and
   If all the criteria are met, the 5G ProSe UE-to-Network Relay may respond with a 5G ProSe UE-to-Network Relay Discovery Response message (Model B) as defined in TS 23.304 [4] clause 5.8.3 with the following modified/additional information:
Hop-Count: this is set to 1.
(optional) Hop-Limit: if there is a hop limit configured on the 5G ProSe UE-to-Network Relay.
   For any Intermediate UE-to-Network Relay received the 5G ProSe UE-to-Network Relay Discovery Response message, it updates/creates a new information entry as described in clause 6.Y.2.1.1, with the Discoveree Info stored as the Root Relay Info.

Single-hop UE-to-Network (U2N) Relay was specified in Release 18. For single-hop U2N Relay, a U2N relay may be used to support data communication between a remote UE and the network in case the remote UE cannot communicate with the network directly. A U2N relay needs to establish one PC5 unicast link (or a PC5 RRC connection) with the remote UE and establish a RRC connection with a network node (e.g. a gNB) to support data communication between the remote UE and the network via the U2N relay. According to 3GPP TS 22.261, multi-hop U2N Relay may be supported in Release 19 and the network operators shall be able to define the maximum number of hops supported in their networks when using relay UEs.

Considering that the more hops are used, the more delays are induced, it is not appropriate for the network to configure one value of the maximum number of hops for services with different QoS requirements. Therefore, it is beneficial for the network to configure the maximum number of hops based on services. For example, the network may provide the maximum number of hops for each (ProSe) Relay Service Code (RSC) to a relay UE so as to limit the maximum number of hops used for multi-hop U2N Relay, where a RSC indicates the connectivity service the U2N Relay provides to the Remote UE. In one embodiment, the network may provide the mapping of maximum number of hops to (ProSe) RSCs to a relay UE or a remote UE. In addition, each RSC may be associated with one or multiple PDU sessions.

According to Section 8.2.1.2 in 3GPP TS 24.554, when a UE is triggered by an upper layer application to announce availability of a connectivity service provided by a UE-to-network relay, the UE (i.e. a UE-to-network Relay UE) shall generate a PROSE PC5 DISCOVERY message for UE-to-network relay discovery announcement and pass the resulting PROSE PC5 DISCOVERY message to the lower layers for transmission over the PC5 interface with the source layer-2 ID, destination layer-2 ID and an indication that the message is for 5G ProSe direct discovery if the UE is authorized to perform the announcing UE procedure for UE-to-network relay discovery. In addition, the UE shall ensure that it keeps on passing the same PROSE PC5 DISCOVERY message along with the same source layer-2 ID, destination layer-2 ID and an indication that the message is for 5G ProSe direct discovery to the lower layers for transmission until the UE is triggered by an upper layer application to stop announcing availability of the connectivity service provided by a UE-to-network relay, or until the UE stops being authorized to perform the announcing UE procedure for UE-to-network relay discovery, and how this is achieved is left up to UE implementation.

As specified in Section 5.8.13.3 of Release 18 in 3GPP TS 38.331, a UE capable of N_{R} sidelink discovery that is configured by upper layer to transmit the N_{R} sidelink discovery message shall examine if the N_{R} sidelink U2N Relay UE threshold conditions specified in Section 5.8.14.2 of Release 18 in 3GPP TS 38.331 can be met. The UE shall not transmit the NR sidelink discovery message if the N_{R} sidelink U2N Relay UE threshold conditions cannot be met. Basically, the U2N Relay UE examines whether the Reference Signal Received Power (RSRP) measurement of the serving or camping cell is between two threshold values derived by threshHighRelay, hystMaxRelay, threshLowRelay, and/or hystMinRelay, if configured by the network. This implies the U2N Relay UE cannot be too close to the cell or too far from the cell so as to transmit the N_{R} sidelink discovery message.

More precisely, the N_{R} sidelink U2N Relay UE threshold conditions may include two cases: (1) the threshold conditions were previously not met; (2) the threshold conditions were previously met. For case (1), the UE shall consider the threshold conditions to be met if the RSRP measurement of the serving cell (e.g. PCell) or the cell on which the UE camps is below threshHighRelay by hystMaxRelay and above threshLowRelay by hystMinRelay. For case (2), the UE shall consider the threshold conditions not to be met if the RSRP measurement of the serving or camping cell is above threshHighRelay or below threshLowRelay. Otherwise, it remains to be met. In other words, for case (2), the UE shall consider the threshold conditions to be met if the RSRP measurement of the serving or camping cell is below (or equal to) threshHighRelay and above (or equal to) threshLowRelay. It is noted that the closer to the cell, the larger the RSRP measurement.

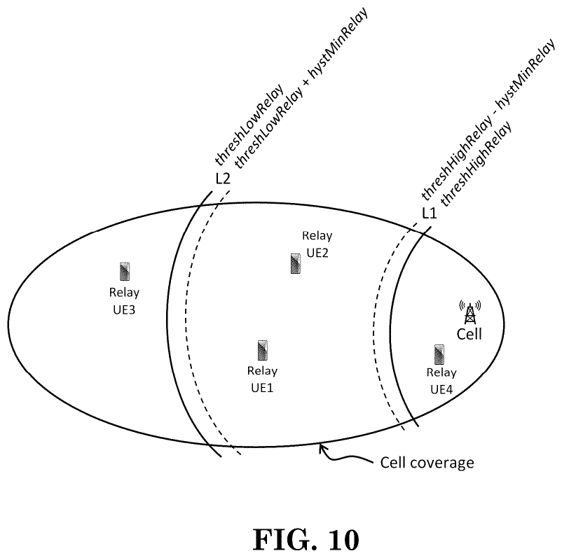

FIG. 10 illustrates examples of relay UE locations w.r.t. its serving or camping cell according to one exemplary embodiment. L1 and L2 correspond to the threshold values (e.g. (threshHighRelay-hystMaxRelay) and (threshLowRelay+hystMinRelay) for Case 1 or threshHighRelay and threshLowRelay for Case 2). Relays UE1, UE2, UE3, and UE4 are all within cell coverage. Relay UE1 and Relay UE2 are between L1 and L2 and thus are qualified for sidelink discovery message transmission in Released 18, while Relay UE3 and UE4 are not qualified in Released 18.

FIG. 6.Y.1-1 (reproduced as FIG. 7) of 3GPP S2-2403687 shows an example architecture of multi-hop UE-to-Network Relay. According to 3GPP S2-2403687, only 5G ProSe UE-to-Network Relay needs to be in coverage of NG-RAN and be able to establish a connection with the NG-RAN and other Intermediate UE-to-Network Relay(s) can be either in coverage (IC) or out of coverage (OOC). In general, a UE is in-coverage (IC) of a network if it is in RRC_IDLE, RRC_INACTIVE, or RRC_CONNECTED. Besides, as illustrated in FIG. 6.Y.2.1.1-1 (reproduced as FIG. 8) of 3GPP S2-2403687, an Intermediate UE-to-Network Relay may forward the Relay Discovery Announcement message to the next Intermediate UE-to-Network Relay or the remote UE if a Relay Discovery Announcement message is received from another relay UE. More precisely, the Intermediate UE-to-Network Relay in fact just forwards some information (e.g. RSC) included in the received Relay Discovery Announcement message and transmits a new Relay Discovery Announcement message which may include different information from what included in the received Relay Discovery Announcement message e.g. the hop count may be increased by 1 and/or an identity of the Intermediate UE-to-Network Relay may be included.

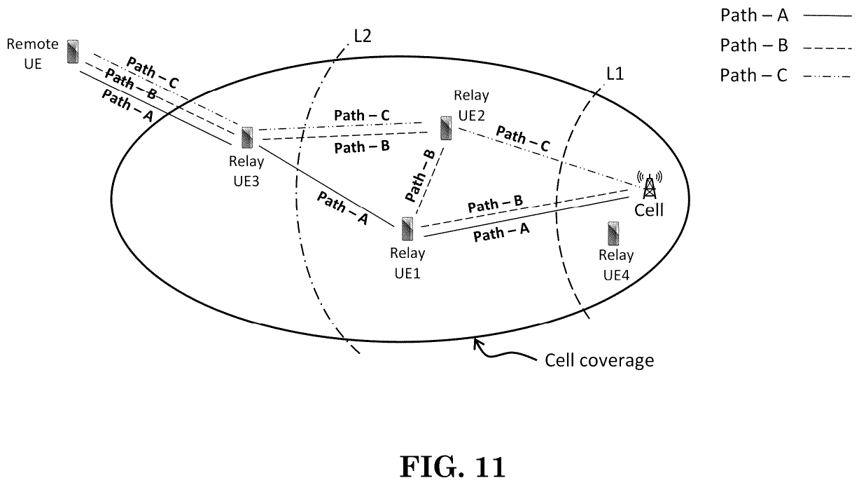

FIG. 11 illustrates three potential relay paths between the Remote UE and the network via multiple U2N relay UEs according to one exemplary embodiment. In FIG. 11, Relay UE2 (acting as an Intermediate UE-to-Network Relay) would forward the Relay Discovery Announcement message when receiving a Relay Discovery Announcement message from Relay UE1 (acting as a 5G ProSe UE-to-Network Relay), which has initiated the announcing UE procedure for UE-to-network relay discovery, according to 3GPP S2-2403687. Relay UE3 (acting as an Intermediate UE-to-Network Relay) may receive the Relay Discovery Announcement message from both Relay UE1 and UE2 and then forward the Relay Discovery Announcement message twice. Besides, Relay UE2 (acting as a 5G ProSe UE-to-Network Relay) may also initiate the announcing UE procedure for UE-to-network relay discovery by itself because it is qualified for sidelink discovery message transmission (according to the NR sidelink U2N Relay UE threshold conditions specified in Section 5.8.14.2 of Release 18 in 3GPP TS 38.331). In this situation, Remote UE may receive three Relay Discovery Announcement messages from Relay UE3 and thus there are three potential relay paths for the Remote UE to select: Path-A (Remote UE-Relay UE3-Relay UE1-Cell), Path-B (Remote UE-Relay UE3—Relay UE2-Relay UE1-Cell), and Path-C(Remote UE-Relay UE3-Relay UE2-Cell).

As discussed above, both Relay UE3 and Relay UE4 in FIG. 11 do not meet the NR sidelink U2N Relay UE threshold conditions and thus are not allowed to transmit the NR sidelink discovery message for single-hop U2N Relay. However, to support multi-hop U2N Relay, it is beneficial for Relay UE3 to forward the Relay Discovery Announcement message received from other relay UE, while Relay UE4 should still not be allowed to forward the Relay Discovery Announcement message because of interference concern w.r.t. the serving/camping cell (due to too close to the cell). In other words, when being configured by the upper layer to transmit N_{R} sidelink discovery message, the U2N Relay UE or the lower layer in the U2N Relay UE is allowed to transmit or broadcast a new Relay Discovery Announcement message if at least the following conditions are met:
(1) the frequency used for sidelink discovery is configured by the network;
(2) the UE is in RRC_CONNECTED or IC of a network; and
(3) the RSRP measurement of the serving or camping cell is below threshLowRelay.

In contrast, the U2N Relay UE or the lower layer in the U2N Relay UE is not allowed to transmit or broadcast a new Relay Discovery Announcement message if the RSRP measurement of the serving or camping cell is above threshHighRelay. In one embodiment, condition (3) also implies IE sl-DiscConfig is included in the RRCReconfiguration message received from the network.

In other words, the U2N Relay UE or the lower layer in the U2N Relay UE may determine whether it is allowed to transmit the new U2N Relay Discovery Announcement message according to at least the RSRP measurement of the serving or camping cell. The U2N Relay UE is allowed to transmit the new U2N Relay Discovery Announcement message if the RSRP measurement is below threshLowRelay and is not allowed to transmit the new U2N Relay Discovery Announcement message if the RSRP measurement is above threshHighRelay.

As illustrated in FIG. 6.Y.2.1.2-1 (reproduced as FIG. 9) of 3GPP S2-2403687, an Intermediate U2N Relay may forward the Relay Discovery Solicitation/Response message to the next UE-to-Network Relay or the remote UE if a Relay Discovery Solicitation/Response message is received from the remote or another relay UE. Thus, the above solution(s) for Relay Discovery Announcement message forwarding may also be applicable to Relay Discovery Solicitation/Response message forwarding by the Intermediate U2N Relay.

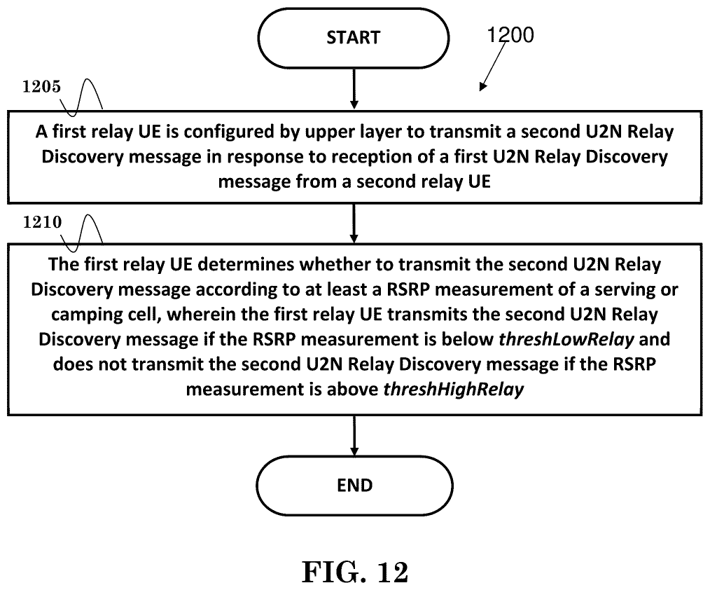

FIG. 12 is a flow chart 1200 for supporting multi-hop UE-to-Network (U2N) relay. In step 1205, a first relay User Equipment (UE) is configured by upper layer to transmit a second U2N Relay Discovery message in response to reception of a first U2N Relay Discovery message from a second relay UE. In step 1210, the first relay UE determines whether to transmit the second U2N Relay Discovery message according to at least a reference signal received power (RSRP) measurement of a serving or camping cell, wherein the first relay UE transmits the second U2N Relay Discovery message if the RSRP measurement is below threshLowRelay and does not transmit the second U2N Relay Discovery message if the RSRP measurement is above threshHighRelay.

In one embodiment, an information indicating the second U2N Relay Discovery message to be transmitted in response to reception of the first U2N Relay Discovery message from the second relay UE could be provided to lower layer of the first relay UE together with the second U2N Relay Discovery message. The first U2N Relay Discovery message may include a relay service code (RSC), a user info identity (ID) of the second relay UE, a first hop count, and/or first root relay info. The second U2N Relay Discovery message may include the RSC, a user info identity (ID) of the first relay UE, a second hop count, and/or second root relay info. The second hop count may be equal to the first hop count plus 1.

In one embodiment, the first U2N Relay Discovery message or the second U2N Relay Discovery message may be a U2N Relay Discovery Announcement message, a U2N Relay Discovery Solicitation message, or a U2N Relay Discovery Response message. threshLowRelay and threshHighRelay could be provided or configured by a network node.

Referring back to FIGS. 3 and 4, in one exemplary embodiment from the perspective of a first relay UE. The first relay UE 300 includes a program code 312 stored in the memory 310. The CPU 308 could execute program code 312 to enable the first relay UE (i) to be configured by upper layer to transmit a second U2N Relay Discovery message in response to reception of a first U2N Relay Discovery message from a second relay UE, and (ii) to determine whether to transmit the second U2N Relay Discovery message according to at least a RSRP measurement of a serving or camping cell, wherein the first relay UE transmits the second U2N Relay Discovery message if the RSRP measurement is below threshLowRelay and does not transmit the second U2N Relay Discovery message if the RSRP measurement is above threshHighRelay. Furthermore, the CPU 308 can execute the program code 312 to perform all of the above-described actions and steps or others described herein.

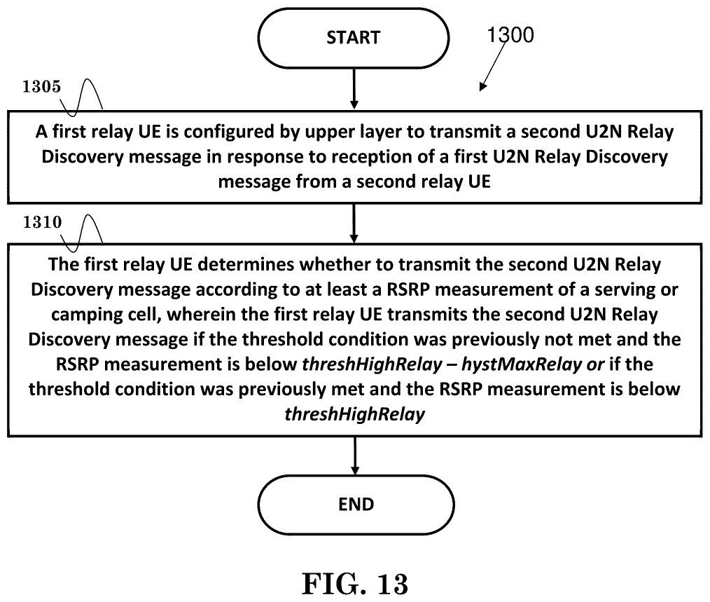

FIG. 13 is a flow chart 1300 for supporting multi-hop UE-to-Network (U2N) relay. In step 1305, a first relay User Equipment (UE) is configured by upper layer to transmit a second U2N Relay Discovery message in response to reception of a first U2N Relay Discovery message from a second relay UE. In step 1310, the first relay UE determines whether to transmit the second U2N Relay Discovery message according to at least a reference signal received power (RSRP) measurement of a serving or camping cell, wherein the first relay UE transmits the second U2N Relay Discovery message if the threshold condition was previously not met and the RSRP measurement is below threshHighRelay-hystMaxRelay or if the threshold condition was previously met and the RSRP measurement is below threshHighRelay.

In one embodiment, an information indicating the second U2N Relay Discovery message to be transmitted in response to reception of the first U2N Relay Discovery message from the second relay UE could be provided to lower layer of the first relay UE together with the second U2N Relay Discovery message. The first U2N Relay Discovery message may include a relay service code (RSC), a user info identity (ID) of the second relay UE, a first hop count, and/or first root relay info. The second U2N Relay Discovery message may include the RSC, a user info identity (ID) of the first relay UE, a second hop count, and/or second root relay info. The second hop count may be equal to the first hop count plus 1.

In one embodiment, the first U2N Relay Discovery message or the second U2N Relay Discovery message may be a U2N Relay Discovery Announcement message, a U2N Relay Discovery Solicitation message, or a U2N Relay Discovery Response message. threshHighRelay and hystMaxRelay may be provided or configured by the network.

In one embodiment, the first relay UE may not take any low threshold (or lower bound) into consideration when determining whether to transmit the second U2N Relay Discovery message according to the RSRP measurement of the serving or camping cell.

Referring back to FIGS. 3 and 4, in one exemplary embodiment from the perspective of a first relay UE. The first relay UE 300 includes a program code 312 stored in the memory 310. The CPU 308 could execute program code 312 to enable the first relay UE (i) to be configured by upper layer to transmit a second U2N Relay Discovery message in response to reception of a first U2N Relay Discovery message from a second relay UE, (ii) to determines whether to transmit the second U2N Relay Discovery message according to at least a RSRP measurement of a serving or camping cell, wherein the first relay UE transmits the second U2N Relay Discovery message if the threshold condition was previously not met and the RSRP measurement is below threshHighRelay-hystMaxRelay or if the threshold condition was previously met and the RSRP measurement is below threshHighRelay. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for supporting multi-hop UE-to-Network (U2N) relay, comprising:
a first relay UE is configured by upper layer to transmit a second U2N Relay Discovery message in response to reception of a first U2N Relay Discovery message from a second relay UE; and
the first relay UE determines whether to transmit the second U2N Relay Discovery message according to at least a reference signal received power (RSRP) measurement of a serving or camping cell,
wherein the first relay UE transmits the second U2N Relay Discovery message if the RSRP measurement is below threshLowRelay and does not transmit the second U2N Relay Discovery message if the RSRP measurement is above threshHighRelay.

2. The method of claim 1, wherein an information indicating the second U2N Relay Discovery message to be transmitted in response to reception of the first U2N Relay Discovery message from the second relay UE is provided to lower layer of the first relay UE together with the second U2N Relay Discovery message.

3. The method of claim 1, wherein the first U2N Relay Discovery message includes a relay service code (RSC), a user info identity (ID) of the second relay UE, a first hop count, and/or first root relay info.

4. The method of claim 3, wherein the second U2N Relay Discovery message includes the RSC, a user info identity (ID) of the first relay UE, a second hop count, and/or second root relay info.

5. The method of claim 4, wherein the second hop count is equal to the first hop count plus 1.

6. The method of claim 1, wherein the first U2N Relay Discovery message or the second U2N Relay Discovery message is a U2N Relay Discovery Announcement message, a U2N Relay Discovery Solicitation message, or a U2N Relay Discovery Response message.

7. The method of claim 1, wherein threshLowRelay and threshHighRelay are provided or configured by a network node.

8. A method for supporting multi-hop UE-to-Network (U2N) relay, comprising:
a first relay UE is configured by upper layer to transmit a second U2N Relay Discovery message in response to reception of a first U2N Relay Discovery message from a second relay UE; and
the first relay UE determines whether to transmit the second U2N Relay Discovery message according to at least a reference signal received power (RSRP) measurement of a serving or camping cell,
wherein the first relay UE transmits the second U2N Relay Discovery message if the threshold condition was previously not met and the RSRP measurement is below threshHighRelay-hystMaxRelay or if the threshold condition was previously met and the RSRP measurement is below threshHighRelay.

9. The method of claim 8, wherein an information indicating the second U2N Relay Discovery message to be transmitted in response to reception of the first U2N Relay Discovery message from the second relay UE is provided to lower layer of the first relay UE together with the second U2N Relay Discovery message.

10. The method of claim 8, wherein the first U2N Relay Discovery message includes a relay service code (RSC), a user info identity (ID) of the second relay UE, a first hop count, and/or first root relay info.

11. The method of claim 10, wherein the second U2N Relay Discovery message includes the RSC, a user info identity (ID) of the first relay UE, a second hop count, and/or second root relay info.

12. The method of claim 11, wherein the second hop count is equal to the first hop count plus 1.

13. The method of claim 8, wherein the first U2N Relay Discovery message or the second U2N Relay Discovery message is a U2N Relay Discovery Announcement message, a U2N Relay Discovery Solicitation message, or a U2N Relay Discovery Response message.

14. The method of claim 8, wherein threshHighRelay and hystMaxRelay are provided or configured by a network node.

15. The method of claim 8, wherein the first relay UE does not take any low threshold or lower bound into consideration when determining whether to transmit the second U2N Relay Discovery message according to the RSRP measurement of the serving or camping cell.

16. A first relay User Equipment (UE), comprising:
a control circuit;
a processor installed in the control circuit; and
a memory installed in the control circuit and operatively coupled to the processor;
wherein the processor is configured to execute a program code stored in the memory to:
be configured by upper layer to transmit a second UE-to-Network (U2N) Relay Discovery message in response to reception of a first U2N Relay Discovery message from a second relay UE; and
determine whether to transmit the second U2N Relay Discovery message according to at least a reference signal received power (RSRP) measurement of a serving or camping cell,
wherein the first relay UE transmits the second U2N Relay Discovery message if the threshold condition was previously not met and the RSRP measurement is below threshHighRelay-hystMaxRelay or if the threshold condition was previously met and the RSRP measurement is below threshHighRelay.

17. The first relay UE of claim 16, wherein the first U2N Relay Discovery message includes a relay service code (RSC), a user info identity (ID) of the second relay UE, a first hop count, and/or first root relay info.

18. The first relay UE of claim 16, wherein the second U2N Relay Discovery message includes the RSC, a user info identity (ID) of the first relay UE, a second hop count, and/or second root relay info.

19. The first relay UE of claim 16, wherein the first U2N Relay Discovery message or the second U2N Relay Discovery message is a U2N Relay Discovery Announcement message, a U2N Relay Discovery Solicitation message, or a U2N Relay Discovery Response message.

20. The first relay UE of claim 16, wherein threshHighRelay and hystMaxRelay are provided or configured by a network node.
